(19) United States
(12) Patent Application Publication
(10) Pub. No.: US 2011/0007024 A1
(43) Pub. Date: Jan. 13, 2011

(54) Whiteboard and Method for Orientation Thereof

(75) Inventors: Cheng-Lu Liu, Hsin-Chu (TW); Yun-Hsiang Yeh, Miaoli (TW); Sheng-Mao Lin, Tainan (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, HSINCHU (TW)

(21) Appl. No.: 12/617,720

(22) Filed: Nov. 12, 2009

(30) Foreign Application Priority Data
Jul. 9, 2009 (TW) 098123283

(51) Int. Cl. G06F 3/045

(52) U.S. Cl. 345/174

(57) ABSTRACT

The present invention relates to a whiteboard and method for orientation thereof, and particularly relates to an electromagnetic-and-interactive whiteboard with a battery-free pointer device and method of the electromagnetic-and-interactive whiteboard for finding the position of the battery-free pointer device. A plurality of signal handling devices are provided in the whiteboard for controlling the antenna boards of the whiteboard to emit electromagnetic power respectively. By this way, the antenna boards do not interfered with each other and the battery-free pointer device can be located precisely without deviation. Furthermore, the electromagnetic power provided by the antenna boards is applied to instead of a battery in battery-free pointer device for providing the power to the battery-free pointer device. The electromagnetic power provided by the antenna boards is used to be the power of the battery-free pointer device for emitting electromagnetic signals. As consequence of this structure of the battery-free pointer device of the whiteboard, the whiteboard of the present invention can meet the demand for environmental protection and more practicability.

### FIELD OF THE INVENTION

The present invention relates to a whiteboard and method for orientation thereof, and particularly relates to an electromagnetic-and-interactive whiteboard with a battery-free pointer device and method of the electromagnetic-and-interactive whiteboard for finding the position of the battery-free pointer device.

### BACKGROUND OF THE INVENTION

In recent years, whiteboards are extensively applied in various meetings, seminars and schools for briefing, interpretation and teaching, and particularly, interactive whiteboards are used to be assistance devices for teaching in classroom and to establish high efficient e-teaching classrooms. For example, fifty percentage of classrooms in elementary schools and junior high schools of Britain use electromagnetic-and-interactive whiteboards for teaching in 2007, and the interactive whiteboards are also gradually used to assist in teaching in other countries, such as U.S., Australia, Hong Kong, Japan, Singapore, Mexico and Malaysia. In Taiwan, Ministry of Education provides some plans to assist part of schools in using the interactive whiteboards for teaching.

According to work principle of the interactive whiteboards, the interactive whiteboards can be classified into four types such as pressure-sensitive type, electromagnetic type, Ultrasonic type and two way infrared type. The electromagnetic type of interactive whiteboards (the electromagnetic-and-interactive whiteboards) are most often used in recent years. Referring to FIG. 1A, it is a perspective form diagram illustrating a conventional electromagnetic-and-interactive whiteboard 10. The electromagnetic-and-interactive whiteboard 10 is assembled by a whiteboard body 20 and an electromagnetic-and-interactive pen 30. The electromagnetic-and-interactive pen 30 has a button 32 for controlling the electromagnetic-and-interactive pen 30 to emit electromagnetic signals, and a battery 34 is fitted into the electromagnetic-and-interactive pen 30 for providing power to emit electromagnetic signals. The whiteboard body 20 has antenna loops 22 X disposed along the direction of X axis therein and antenna loops 22 Y disposed along the direction of Y axis therein, as FIG. 1B shows. The antenna loops 22X and 22Y are used to receive the electromagnetic signals emitted from the electromagnetic-and-interactive pen 30 and to calculate the position of the electromagnetic-and-interactive pen 30.

In the orientation method of the conventional electromagnetic-and-interactive whiteboard 10 for finding or getting the position coordinate of the electromagnetic-and-interactive pen 30 on the conventional electromagnetic-and-interactive whiteboard 10, the electromagnetic signals emitted form the electromagnetic-and-interactive pen 30 are received by the antenna loops 22X and 22Y inside the whiteboard body 20, and then the position coordinate of the electromagnetic-and-interactive pen 30 is calculating according to the received electromagnetic signals. The intensity of the magnetic field is inversely proportional to the square of the distance. Therefore, the distance between the antenna loop and the electromagnetic-and-interactive pen 30 is longer, the intensity of the electromagnetic signals of the electromagnetic-and-interactive pen 30 received by the antenna loop is weaker. On the contrary, the distance between the antenna loop and the electromagnetic-and-interactive pen 30 is shorter, the intensity of the electromagnetic signals of the electromagnetic-and-interactive pen 30 received by the antenna loop is stronger. Therefore, the intensity of the electromagnetic signals received by all antenna loops is detected and collected, and then the precise position coordinate of the electromagnetic-and-interactive pen 30 can be gotten after analyzing and calculating according to the electromagnetic signals.

In recent years, with the trend for environmental protection, the use of the battery is reduced and replaced gradually because the waste battery pollutes environment. However, the electromagnetic-and-interactive pen 30 of the conventional electromagnetic-and-interactive whiteboard 10 has a need that a battery is provided to be the power supply of the electromagnetic-and-interactive pen 30. Therefore, the conventional electromagnetic-and-interactive whiteboard 10 can not meet the demand for environmental protection. However, when the battery is provided in the electromagnetic-and-interactive pen 30 to be the power for emitting electromagnetic signals, user can not know how much electricity the battery still has now. Therefore, the battery in the electromagnetic-and-interactive pen 30 can not be change timely. It is inconvenient to use the electromagnetic-and-interactive pen 30 because user can not immediately know that the battery has no electricity and can not change a new battery into the electromagnetic-and-interactive pen 30 in time. All of the present electromagnetic-and-interactive whiteboards, which we can see or buy, use the interactive pointer device with a battery, such as the electromagnetic-and-interactive pen with a battery to be the power for emitting electromagnetic signals. However, there is no whiteboard with battery-free pointer device to be provided presently.

Therefore, there is a need to provide an electromagnetic-and-interactive whiteboard with a battery-free pointer device and method of the electromagnetic-and-interactive whiteboard for finding the position of the battery-free pointer device. Therefore, a battery-free pointer device can be applied to a whiteboard but the position of the battery-free pointer device still can be found precisely. Furthermore, the pointer device can be work continuously without battery and the whiteboard can meet the demand for environmental protection and more practicability

### SUMMARY OF THE INVENTION

An objective of this invention is to provide a whiteboard wherein a battery-free pointer device can be applied to the whiteboard and the position of the battery-free pointer device still can be found by the whiteboard precisely. Furthermore, a requirement of the battery can be omitted form the pointer device to meet the demand for environmental protection but the pointer device and the whiteboard still can be worked continuously without battery.

Another objective of this invention is to provide an orientation method of the whiteboard. By the method, a battery-free pointer device can be applied to the whiteboard and the position coordinate of the battery-free pointer device can be calculated and found by the whiteboard precisely. Furthermore, the antenna boards in the whiteboard do not interfered with each other and the position of the battery-free pointer device can be detected or found precisely without deviation.

In one embodiment of the present invention, a whiteboard having a battery-free pointer device applied to is disclosed. The battery-free pointer device is applied to an electromagnetic-and-interactive whiteboard in this invention. The whiteboard has a battery-free pointer device for handwriting input and function selection and a whiteboard body for the battery-free pointer device moving freely thereon. The whiteboard body has several antenna boards disposed therein for emitting electromagnetic power to the battery-free pointer device, for receiving electromagnetic signals emitted by the battery-free pointer device, for providing the power to the battery-free pointer device and for finding position of said battery-free pointer. Furthermore, each of the antenna boards has a corresponded signal handling device for controlling the antenna board to emit electromagnetic power and for managing the emitting order of the antenna boards. Besides, each of the signal handling devices is also used to inform the other signal handling devices corresponded to other antenna boards to turn on for emitting the electromagnetic power and to turn off for stopping emitting the electromagnetic power. In the whiteboard, each of the antenna boards is corresponded to one of the signal handling devices respectively so the battery-free pointer device can be applied to the whiteboard and the position of the battery-free pointer device still can be detected or found precisely without deviation. Furthermore, the whiteboard can meet the demand for environmental protection and more practicability because the battery-free pointer device is applied to the whiteboard.

In another embodiment of the present invention, an orientation method of the whiteboard for applying a battery-free pointer device to a whiteboard and for finding the precise position of the battery-free pointer device on the whiteboard is disclosed. The whiteboard has a battery-free pointer device, several antenna boards and several signal handling devices. The orientation method of the whiteboard comprises following steps: First, the signal handling devices control all of the antenna boards to emit electromagnetic power simultaneously. Next, the battery-free pointer device receives the electromagnetic power emitted from one of the antenna boards and stores the electromagnetic power, and the battery-free pointer device emits the electromagnetic signals by the stored electromagnetic power. When the antenna board which the battery-free pointer device is put on receives the electromagnetic signals emitted from the battery-free pointer device, the antenna board which the battery-free pointer device is put on informs the corresponded signal handling device that the electromagnetic signals are received by this antenna board. After the antenna board informs the signal handling device that the antenna board has received the electromagnetic signals, the signal handling device informs the other signal handling devices corresponded to the other antenna boards in the whiteboard (the antenna boards in the whiteboard without the battery-free pointer device putting on) to stop emitting electromagnetic power. When the signal handling devices corresponded to the antenna boards without the battery-free pointer device putting on receive the information passed from the signal handling devices corresponded to antenna board with the battery-free pointer device putting on, the signal handling devices corresponded to the antenna boards without the battery-free pointer device putting on stop the corresponded antenna boards from emitting the electromagnetic power respectively. By this method, not only the battery-free pointer device can be applied to the whiteboard, but also the precise position coordinate of the battery-free pointer device on the whiteboard can be calculated and gotten. In this orientation method, when one of the antenna boards receives the electromagnetic power, the other antenna boards stop emitting the electromagnetic power immediately. Therefore, the antenna boards do not interfered by the electromagnetic power emitted from the other antenna boards and the antenna board can find and trace the precise position of the battery-free pointer device without deviation.

Therefore, the effect achieved with the present invention is to provide a whiteboard and an orientation method of the whiteboard with the battery-free pointer device. The battery-free pointer device is applied to the whiteboard and the position of battery-free pointer device still can be found precisely by the whiteboard without deviation resulting from the interference between the antenna boards. Furthermore, the whiteboard of the present invention can meet the demand for environmental protection and more practicability because it has no need to use a battery as a power supply of the pointer device.

### BRIEF DESCRIPTION OF THE DRAWINGS

FIG. 1A is a perspective form diagram illustrating a conventional electromagnetic-and-interactive whiteboard.

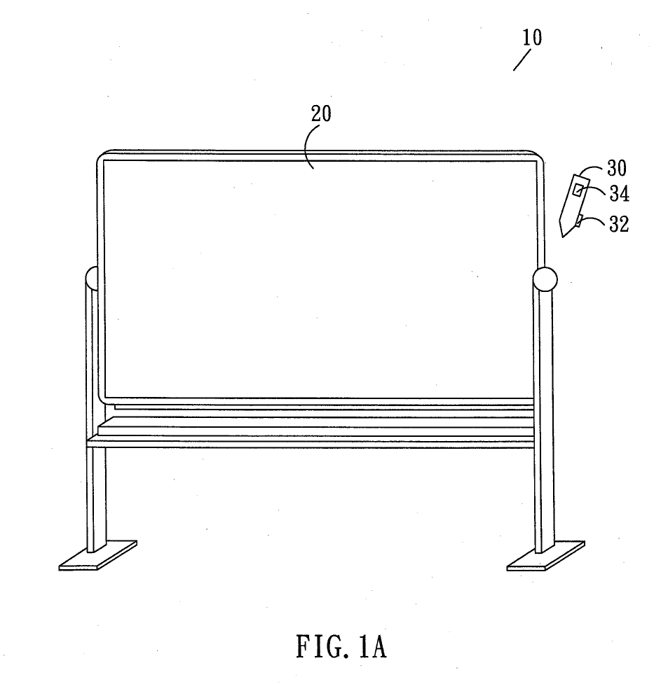

FIG. 1B is a plane form diagram illustrating an antenna board in the conventional electromagnetic-and-interactive whiteboard of FIG. 1A.

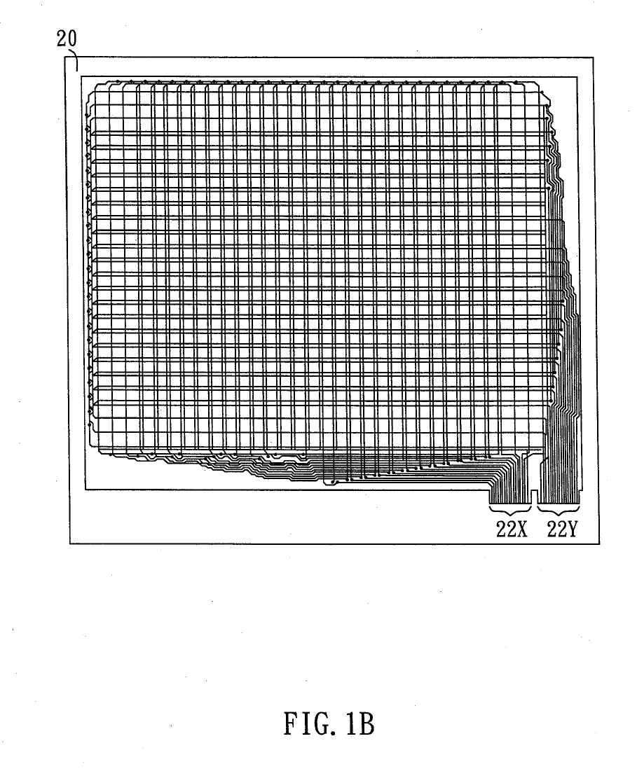

FIG. 2A is a plane form diagram illustrating an electromagnetic-and-interactive whiteboard in accordance with an embodiment of the present invention.

FIG. 2B is a plane form diagram illustrating the inner structure of an antenna board in an electromagnetic-and-interactive whiteboard of FIG. 2A.

FIG. 3 is a flow chart illustration of an orientation method of the whiteboard for finding the position of the battery-free pointer device on the whiteboard in accordance with an embodiment of the present invention.

### DESCRIPTION OF THE EXEMPLARY EMBODIMENTS

Although the present invention will be described in accordance with the embodiments shown below, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

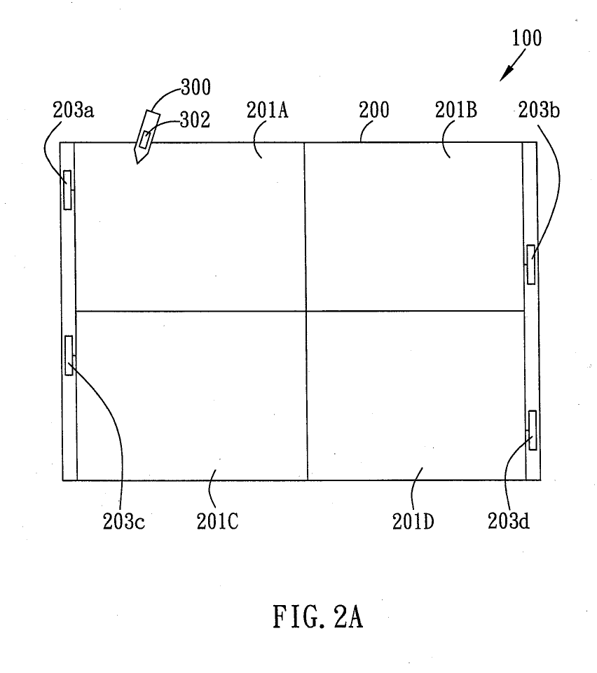

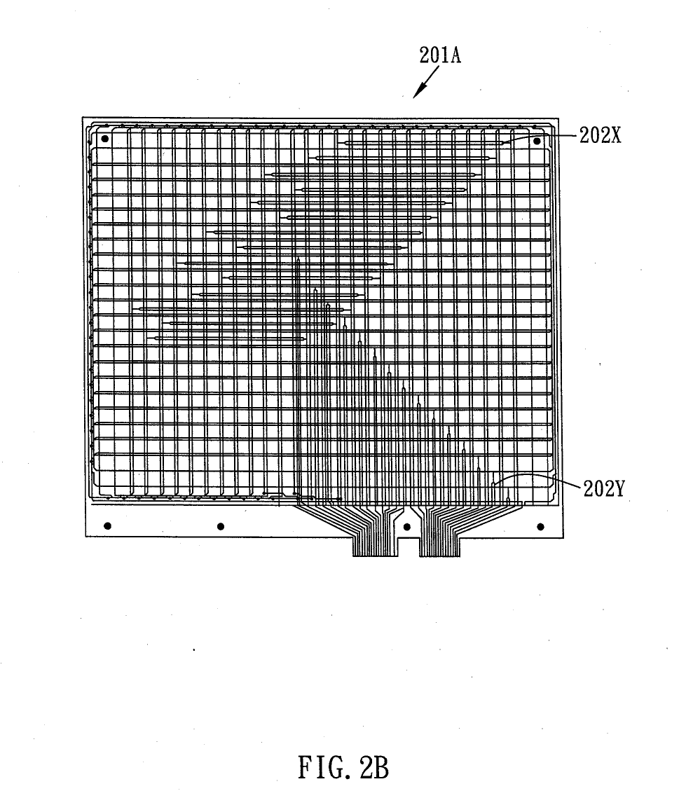

Referring to FIG. 2A, it is a plane form diagram illustrating a whiteboard 100 in accordance with an embodiment of the present invention. The whiteboard 100 is an electromagnetic-and-interactive whiteboard. The whiteboard 100 comprises a whiteboard body 200 and a battery-free pointer device 300, wherein the battery-free pointer device 300 can freely move on the whiteboard body 200 for handwriting input or function selection.

The whiteboard body 200 has several antenna boards 201A, 201B, 201C, 201D and several signal handling devices 203a, 203b, 203c, 203d disposed therein. Each of the antenna boards 201A, 201B, 201C, 201D is corresponded to one of the signal handling devices 203a, 203b, 203c, 203d. As FIG. 2A shows, the antenna board. 201A is corresponded to the signal handling device 203a, the antenna board. 201B is corresponded to the signal handling device 203b, the antenna board. 201C is corresponded to the signal handling device 203c and the antenna board. 201D is corresponded to the signal handling device 203d. The antenna boards 201A, 201B, 201C, 201D are arranged in the whiteboard body 200 for emitting the electromagnetic power to the battery-free pointer device 300 and for receiving the electromagnetic signals emitted from the battery-free pointer device 300. The battery-free pointer device 300 receives the electromagnetic power emitted by the antenna board and store the electromagnetic power to be the power of the battery-free pointer device 300 for emitting the electromagnetic signals. The position coordinate of the battery-free pointer device 300 is found, calculated, or detected according to the electromagnetic signals. Each of the signal handling devices 203a, 203b, 203c, 203d is used to control the corresponded antenna board 201A, 201B, 201C, 201D to turn on or turn off the emission of the electromagnetic power and to process the electromagnetic signals emitted from the battery-free pointer device 300 to the antenna boards 201A, 201B, 201C, 201D for getting the position coordinate of the battery-free pointer device 300 and tracing the move of the battery-free pointer device 300.

In this embodiment, the whiteboard body 200 is composed of four antenna boards 201A, 201B, 201C, 201D, but not limit. The whiteboard body 200 can be composed of less or more antenna boards according to the desired size of whiteboard body. For example, if people need a smaller whiteboard, the whiteboard body can be composed of two antenna boards. In contrast, if people need a larger whiteboard, the whiteboard body can be composed of six, eight or more antenna boards.

Each of the antenna boards 201A, 201B, 201C, 201D has one or more antenna loops disposed therein for emitting the electromagnetic power and receiving the electromagnetic signals. Referring to FIG. 2B, it is a plane form diagram illustrating the inner structure of the antenna board 201A in an electromagnetic-and-interactive whiteboard of FIG. 2A. The other antenna boards 201B, 201C, and 201D have the same structure as the antenna board 201A. Several antenna loops 202X are disposed spread along the X axis and spread along the X axis, and several antenna loops 202Y are disposed spread along the Y axis and spread along the Y axis. Each of the antenna boards 201A, 201B, 201C, 201D is controlled by their own corresponded signal handling devices 203a, 203b, 203c, or 203d respectively. Furthermore, each of signal handling devices 203a, 203b, 203c, 203d controls the antenna loops 202X and 202Y in the corresponded antenna board (201A, 201B, 201C, or 201D) to emit the electromagnetic power one by one in order and to receive the electromagnetic signals emitted from the battery-free pointer device 300 for detecting which antenna board the battery-free pointer device 300 is put on and for getting the precise position coordinate of the battery-free pointer device 300.

Referring to FIG. 2B again, the battery-free pointer device 300 has an electromagnetic induction coil 302 therein for inducing the electromagnetic power emitted by the antenna boards 201A, 201B, 201C, 201D and storing the electromagnetic power to be the power for the battery-free pointer device 300 emitting the electromagnetic signals. Furthermore, the electromagnetic induction coil 302 is also used to emit the electromagnetic signals to the antenna boards 201A, 201B, 201C, 201D and the antenna boards 201A, 201B, 201C, 201D can induce or receive the electromagnetic signals to calculate or get the position coordinate of the battery-free pointer device 300. In this embodiment, the battery-free pointer device 300 is a battery-free electromagnetic pen, but not limit. Any pointer device having the electromagnetic induction coil can be applied in this invention. In this embodiment, the battery-free pointer device can have a button and a button circuit. Therefore, user can press the button to control the button circuit to change the frequency of the electromagnetic signals emitted from the battery-free pointer device for changing the function of the battery-free pointer device or for selecting function on the whiteboard.

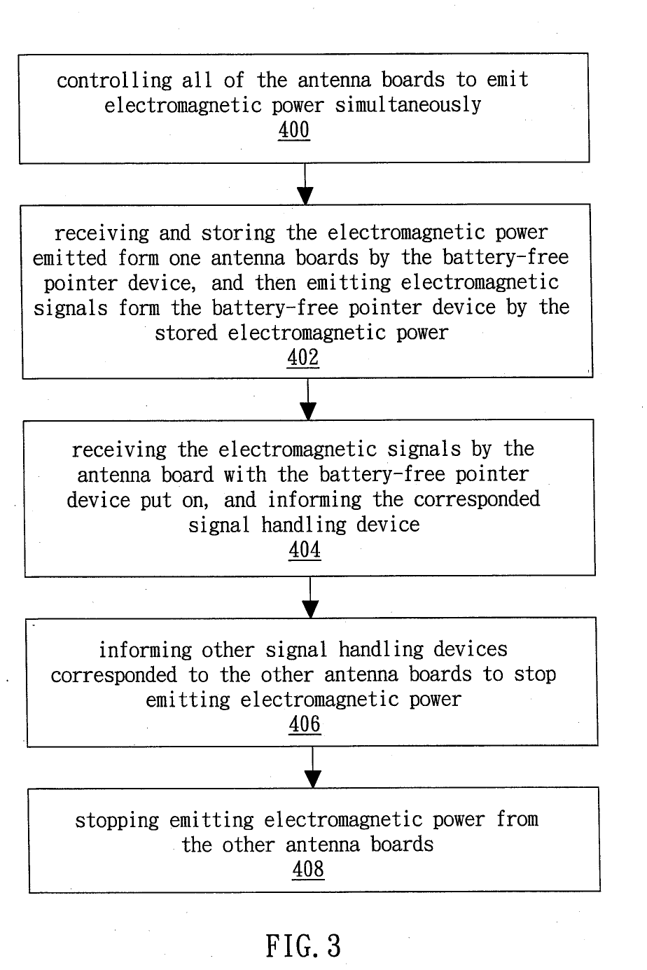

The operation and the orientation method of the whiteboard 100 are illustrated as following description. Referring to FIG. 2A, 2B and 3 simultaneously, FIG. 3 is a flow chart illustration of an orientation method of the whiteboard for finding the position of the battery-free pointer device on the whiteboard in accordance with an embodiment of the present invention. First, the signal handling devices 203a, 203b, 203c, and 203d respectively control their own corresponded antenna boards 201A, 201B, 201C, and 201D to emit electromagnetic power simultaneously and so all of the antenna boards 201A, 201B, 201C, 201D emit electromagnetic power simultaneously for detecting which antenna bard the battery-free pointer device 300 is put on (step 400). Each of the signal handling devices 203a, 203b, 203c, 203d respectively controls the antenna loops in it's own corresponded antenna board 201A, 201B, 201C, or 201D to emit electromagnetic power one by one in order. Take the antenna board 201A as an example, first, the signal handling device 203a controls the antenna board 201A to turn on the first antenna loop in the antenna board 201A for emitting electromagnetic power and then the first antenna loop in the antenna board 201A is turned off. After, the signal handling device 203a controls the antenna board 201A to turn on the second antenna loop in the antenna board 201A for emitting electromagnetic power and then the second antenna loop in the antenna board 201A is turned off. Repeating foregoing steps to turn on and turn off other antenna loops until the last antenna loop is turned on and the turned off. Therefore, all of the antenna loops in the antenna board 201A emit the electromagnetic power one by one in order according to foregoing steps and orders. The antenna boards 201B, 201C, 201D also control the antenna loops disposed therein to emit the electromagnetic power one by one in order according to foregoing steps and orders. Therefore, all of the antenna boards 201A, 201B, 201C, 201D emit the electromagnetic power simultaneously. It means that when the signal handling device 203a controls the first antenna loop in the antenna board 201A to emit electromagnetic power, the signal handling devices 203b, 203c, 203d control the first antenna loop in their own corresponded antenna boards 201B, 201C, 201D to emit the electromagnetic power at the same time.

Next, the battery-free pointer device 300 receives the electromagnetic power emitted by one of the antenna boards 201A, 201B, 201C, 201D, and particular receives the electromagnetic power emitted by the antenna board which the battery-free pointer device 300 is put on. Take FIG. 2A as an example, the battery-free pointer device 300 is put on the antenna board 201A and the battery-free pointer device 300 receives the electromagnetic power emitted by the antenna board 201A. After receiving the electromagnetic power, the battery-free pointer device 300 inducing or receiving the electromagnetic power and stores the electromagnetic power to be the power of the battery-free pointer device 300, and then the battery-free pointer device 300 emits the electromagnetic signals for orienting and get the position of the battery-free pointer device 300 (step 402).

After, the antenna board 201A receives the electromagnetic signals emitted from the battery-free pointer device 300 because the battery-free pointer device 300 is put on the antenna board 201A, and then the antenna board 201A informs the signal handling device 203a that the antenna board 201A has detected the battery-free pointer device 300 put on the antenna board 201A (step 404). At the same time of informing the antenna board 201A, the electromagnetic signals received by the antenna board 201A are sent to the signal handling device 203a by the antenna board 201A. After the signal handling device 203a receives the information and the electromagnetic signals, the signal handling device 203a informs the other signal handling devices 203b, 203c, 203d respectively corresponded to the other antenna boards 201B, 201C, 201D that the antenna board 201A has detected the battery-free pointer device 300. And at the same time, the signal handling device 203a also informs the other signal handling devices 203b, 203c, 203d to control the other antenna board 201B, 201C, 201D to stop emitting the electromagnetic power (step 406). When the other signal handling devices 203b, 203c, 203d receive the information sent from the signal handling device 203a, the signal handling devices 203b, 203c, 203d control their own corresponded antenna boards 201B, 201C, 201D to stop emitting the electromagnetic power (step 408) for preventing the antenna board 201A from the interference caused by the electromagnetic power emitted from the antenna boards 201B, 201C, 201D. Therefore, the antenna board 201A can detect and get the precise position of the battery-free pointer device 300 without deviation.

In foregoing operation and the orientation method of the whiteboard 100, after the antenna board 201A, which the battery-free pointer device 300 is put on (as FIG. 2A shows), receives the electromagnetic signals emitted from the battery-free pointer device 300 and pass the electromagnetic signals to the signal handling device 203a, a calculating step is performed by the signal handling device 203a. In the calculating step, the signal handling device 203a collects the information about the intensity of the electromagnetic signals received by each of the antenna loops in the antenna board 201A and calculates to get the precise position coordinate of the battery-free pointer device 300 according to the information.

When the battery-free pointer device 300 move form the antenna board 201A to the antenna board adjacent to the antenna board 201A, such as the antenna board 201B, 201C, 201D, the antenna board 201A continuously scans to trace the battery-free pointer device 300. Furthermore, when the battery-free pointer device 300 move to the boundary between the antenna board 201A and the adjacent antenna board, the whiteboard 100 performs an informing step. When the battery-free pointer device 300 move from the antenna board 201A toward the boundary between the antenna board 201A and the adjacent antenna board, the signal handling device 203a of the antenna board 201A informs the antenna board, which the battery-free pointer device 300 move toward, to prepare for emitting the electromagnetic power and for detecting the position of the battery-free pointer device 300. Take FIG. 2A as an example, when the battery-free pointer device 300 move from the antenna board 201A toward the antenna board 201C, the signal handling device 203a performs the informing step. In other words, when the battery-free pointer device 300 move to the boundary between the antenna boards 201A and 201C, the signal handling device 203a informs the signal handling device 203c of the antenna board 201C to prepare for emitting the electromagnetic power. When the battery-free pointer device 300 move to the antenna board 201C, the antenna board 201A will not receive any electromagnetic signals emitted from the battery-free pointer device 300. At this time, the signal handling device 203a informs the signal handling device 203c of the antenna board 201C to start to emit the electromagnetic power for keeping tracing the move and the position coordinate of the battery-free pointer device 300.

Besides, when the battery-free pointer device moves away from the antenna board, which the battery-free pointer device is put on previously, without moving to any other antenna boards of the whiteboard, the whiteboard performs a resetting step for informing all of the signal handling devices in the whiteboard to control all of the antenna boards to simultaneously emit the electromagnetic power again for searching the position of the battery-free pointer device. Take FIG. 2A as an example, when the battery-free pointer device 300 move away from the antenna board 201A and does not move to any other antenna boards 201B, 201C, 201D, the signal handling device 203a informs the other signal handling devices 203b, 203c, 203d to control the antenna boards 201B, 201C, 201D to emit the electromagnetic power again. Therefore, all of the antenna boards 201A, 201B, 201C, 201D are controlled by the signal handling devices 203a, 203b, 203c, 203d respectively to emit the electromagnetic power simultaneously again and the position of the battery-free pointer device 300 is searched and detected again.

Therefore, a whiteboard and an orientation method of the whiteboard with the battery-free pointer device are provides in this invention. The battery-free pointer device is applied to the whiteboard and the position of battery-free pointer device still can be found precisely by the whiteboard without deviation resulting from the interference between the antenna boards. Furthermore, the whiteboard of the present invention can meet the demand for environmental protection and more practicability because it has no need to use a battery as a power supply of the pointer device.

What is claimed is:

1. A whiteboard, comprising:
a battery-free pointer device for handwriting input and function selection;
a whiteboard body for said battery-free pointer device moving freely thereon, wherein said whiteboard body comprises;
a plurality of antenna boards disposed in said whiteboard body for emitting electromagnetic power to said battery-free pointer device, for receiving electromagnetic signals emitted by said battery-free pointer device, and for finding position of said battery-free pointer; and
a plurality of signal handling devices for controlling said antenna boards to emit electromagnetic power and for processing the electromagnetic signals which antenna boards receive form said battery-free pointer device, wherein each of said antenna boards is corresponded to one of said signal handling devices respectively.

2. The whiteboard of claim 1, wherein said battery-free pointer device has an electromagnetic induction coil for inducing the electromagnetic power emitted from said antenna boards and storing the electromagnetic power to be the power of said battery-free pointer device for emitting the electromagnetic signals.

3. The whiteboard of claim 1, wherein each of said antenna boards has several antenna loops therein for emitting electromagnetic power and receiving electromagnetic signals.

4. The whiteboard of claim 3, wherein said signal handling devices control said antenna loops in all of said antenna boards to emit electromagnetic power simultaneously for detecting which one of said antenna boards said battery-free pointer device is put on.

5. The whiteboard of claim 4, wherein each of said signal handling devices is corresponded to one of said antenna boards and each of said signal handling devices controls said antenna loops in said corresponded antenna board to emit electromagnetic power one by one in order and to detect which one of said antenna boards said battery-free pointer device is put on and the precise position of said battery-free pointer device on said antenna board.

6. The whiteboard of claim 5, wherein said battery-free pointer device receives the electromagnetic power emitted by said antenna board which said battery-free pointer device is put on, and then said battery-free pointer device stores the electromagnetic power to be the power of said battery-free pointer device for emitting the electromagnetic signals to said antenna board which said battery-free pointer device is put on.

7. The whiteboard of claim 6, wherein when one of said antenna boards receives the electromagnetic signals emitted from said battery-free pointer device, said signal handling device corresponded to said antenna board receiving the electromagnetic signals informs the other signal handling devices corresponded to the other antenna boards to stop emitting the electromagnetic power, and then said the other signal handling devices corresponded to the other antenna boards controls said the other antenna boards to stop emitting the electromagnetic power

8. The whiteboard of claim 7, wherein said antenna board with said battery-free pointer device put on receives the electromagnetic signals emitted from said battery-free pointer device, and then said antenna board calculates to get the position of said battery-free pointer device according to the electromagnetic signals.

9. The whiteboard of claim 7, wherein said antenna board which said battery-free pointer device is put on inform the antenna board adjacent to said antenna board which said battery-free pointer device is put on to prepare for emitting the electromagnetic power and detecting the position of said battery-free pointer device, when said battery-free pointer move to a boundary between said antenna board which said battery-free pointer device is put on and the antenna board adjacent to it.

10. The whiteboard of claim 1, wherein said whiteboard body has four antenna boards.

11. The whiteboard of claim 1, wherein said battery-free pointer device is a battery-free electromagnetic pen.

12. A orientating method of a whiteboard, wherein said whiteboard has a battery-free pointer device and several antenna boards and each of said antenna boards has a signal handling device corresponded to it, said orientating method comprising:
controlling all of said antenna boards to emit electromagnetic power simultaneously by said signal handling devices;
receiving and storing the electromagnetic power emitted form one of said antenna boards by said battery-free pointer device, and then emitting electromagnetic signals form said battery-free pointer device by the stored electromagnetic power;
receiving the electromagnetic signals by said antenna board which said battery-free pointer device is put on, and informing said signal handling device corresponded to said antenna board that said battery-free pointer device is put on said antenna board;
informing the other signal handling devices corresponded to the other antenna boards to stop emitting electromagnetic power by said signal handling device corresponded to said antenna board which said battery-free pointer device is put on; and
stopping emitting electromagnetic power from said the other antenna boards, wherein said signal handling devices corresponded to said the other said antenna boards controls said the other antenna boards to stop emitting electromagnetic power.

13. The method of claim 12, wherein each of said antenna boards has a several antenna loops.

14. The method of claim 13, wherein in said step of emitting electromagnetic power form all of said antenna boards simultaneously, said signal handling devices turn on said antenna loops in said corresponded antenna boards to emit electromagnetic power one by one in order for controlling all of said antenna boards to emit electromagnetic power simultaneously.

15. The method of claim 12, further comprising a calculating step for calculating position coordinate of said battery-free pointer device, wherein said signal handling device corresponded to the antenna board which said battery-free pointer device is put on calculates to get the precise position coordinate of said battery-free pointer device according to the electromagnetic signals received by said signal handling device.

16. The method of claim 12, further comprising an informing step for informing the antenna board adjacent to said antenna board which said battery-free pointer device is put on to prepare for emitting the electromagnetic power.

17. The method of claim 16, wherein in said informing step, said signal handling device corresponded to said antenna board which said battery-free pointer device is put on informs said adjacent antenna board to prepare for emitting the electromagnetic power and detecting the position of said battery-free pointer device, when said battery-free pointer move to a boundary between said antenna board which said battery-free pointer device is put on and said adjacent antenna board.

18. The method of claim 16, further comprising a resetting step, wherein all of said signal handling device are informed to control said corresponded antenna boards to emit electromagnetic power when said battery-free pointer move away from the antenna board which said battery-free pointer is put originally and the antenna board which said battery-free pointer is put originally can not receives the electromagnetic signals emitted from said battery-free pointer.
